(19) United States
(12) Patent Application Publication
(10) Pub. No.: US 2021/0329604 A1
(43) Pub. Date: Oct. 21, 2021

(54) Physical Layer Enhancements for Sidelink Communication

(71) Applicant: MediaTek Singapore Pte. Ltd., Singapore (SG)

(72) Inventor: Tao Chen, Beijing (CN)

(21) Appl. No.: 17/238,929

(22) Filed: Apr. 23, 2021

Related U.S. Application Data
(63) Continuation of application No. PCT/CN2020/086641, filed on Apr. 24, 2020.

(30) Foreign Application Priority Data
Apr. 20, 2020 (CN) CN202110433633.1

(51) Int. Cl. H04W 72/04; H04W 24/10

(52) U.S. Cl. CPC H04W 72/04; H04W 24/10

(57) ABSTRACT

Apparatus and methods are provided for physical layer enhancements for sidelink communication. In one novel aspect, the SL CSI reporting configuration is determined explicitly by signaling or implicitly by mapping between the CSI table for the SL CSI reporting and the MCS table. In one embodiment, the explicit signaling is the second sidelink control information (SCI) with non-scrambled bit information. In another embodiment, the SL CSI reporting configuration is implicitly mapped based on the MCS table in the first SCI. In another embodiment, the new aperiodic SL CSI reporting is prohibited until a prior first aperiodic SL CSI reporting is completed. The first SL CSI reporting is completed upon detecting one or more conditions comprising a successfully reception of the first SL CSI reporting, a maximum number or retransmission is reached, and a SL CSI reporting latency timer expired.

### CROSS REFERENCE TO RELATED APPLICATIONS

This application is filed under 35 U.S.C. § 111(a) and is based on and hereby claims priority under 35 U.S.C. § 120 and § 365(c) from International Application No. PCT/CN/2020/086641, titled “Physical Layer Enhancement for SL Communication,” with an international filing date of Apr. 24, 2020. This application claims priority under 35 U.S.C. § 119 from Chinese Application Number CN 202110433633.1, titled “Physical Layer Enhancement for Sidelink Communication,” filed on Apr. 20, 2021. The disclosure of each of the foregoing documents is incorporated herein by reference.

### TECHNICAL FIELD

The disclosed embodiments relate generally to wireless communication, and, more particularly, to physical layer enhancements for sidelink communication.

### BACKGROUND

5G radio access technology will be a key component of the modern access network. It will address high traffic growth and increasing demand for high-bandwidth connectivity. In 3GPP New Radio (NR), sidelink continues evolving. With new functionalities supported, the sidelink (SL) offers low latency, high reliability and high throughout for device-to-device communications. NR vehicle to everything (V2X) supports sidelink measurement. The V2X sidelink communication can be supported by unicast, groupcast, and broadcast. To support efficient sidelink communication, the sidelink channel state information (CSI) reporting procedure needs to consider resource allocation and CSI reporting procedures specific to the configuration of the sidelink. The sidelink also has a physical sidelink feedback channel (PSFCH). The physical sidelink shared channel (PSSCH) transport block size (TBS) determination are needed for the sidelink communication. Further the slot configuration for SL shares common attributes with the existing Uu links. Share the configuration information for the sidelink and the Uu link provides efficiency for the system. However, the sidelink can be configured with different numerologies. The slot configuration requires additional steps.

Improvements and enhancements are required for physical layer, including the sidelink channel state information (CSI) reporting configuration and procedure, PSSCH TBS determination, prioritization between SL and UL transmission, and slot configuration.

### SUMMARY

Apparatus and methods are provided for physical layer enhancements for sidelink communication. In one novel aspect, the SL CSI reporting configuration is determined explicitly by signaling or implicitly by mapping between the CSI table for the SL CSI reporting and the MCS table. In one embodiment, the explicit signaling is the second sidelink control information (SCI) with non-scrambled bit information. In another embodiment, the SL CSI reporting configuration is implicitly mapped based on the MCS table in the first SCI.

In another embodiment, only one CSI reporting process is allowed to avoid the out-of-order delivery of the CSI reports carried in the MAC layer suffering from the HARQ delay. In one embodiment, the new aperiodic SL CSI reporting is prohibited until a prior first aperiodic SL CSI reporting is completed. The first SL CSI reporting is completed upon detecting one or more conditions comprising a successfully reception of the first SL CSI reporting, a maximum number or retransmission is reached, and a SL CSI reporting latency timer expired.

In yet another embodiment, for SL PSSCH TBS determination, a PSFCH overhead indicator carried in 2nd SCI can be used to indicate whether the average or zero PSFCH overhead is assumed for a TB across the initial transmission and re-transmission(s). This can secure the same TB across all (re-)transmissions for a TB while providing the possibility of achieving the peak data rate by only using the slots without PSFCH. In one embodiment, the prioritization is performed when the SL and UL overlaps. In another embodiment, a reference pattern of TDD configuration can be assumed to derive the UL slots for some TDD patterns.

This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a schematic system diagram illustrating an exemplary wireless network for physical layer enhancements for sidelink communication in accordance with embodiments of the current invention.

FIG. 2 illustrates an exemplary NR wireless system with centralized upper layers of the NR radio interface stacks in accordance with embodiments of the current invention.

FIG. 3 illustrates an exemplary top-level functional diagram for the physical layer enhancements for the sidelink communication in accordance with embodiments of the current invention.

FIG. 4 illustrates exemplary diagrams for the SL CSI reporting configuration in accordance with embodiments of the current invention.

FIG. 5 illustrates exemplary diagrams for the SL CSI reporting procedure performed without multiple CSI reporting in parallel in accordance with embodiments of the current invention.

FIG. 6 illustrates exemplary diagrams for using the PSFCH overhead indicator for SL PSSCH TBS determination in accordance with embodiments of the current invention.

FIG. 7 illustrates exemplary diagrams for the prioritization performed between S-SSB and the UL transmission when overlapping in accordance with embodiments of the current invention.

FIG. 8 illustrates exemplary diagrams for SL slot configuration that derives UE UL or SL dual-period patterns with the same period on P1 and P2 from a reference dual-period pattern in accordance with embodiments of the current invention.

FIG. 9 illustrates an exemplary flow chart for the SL CSI reporting configuration in accordance with embodiments of the current invention.

FIG. 10 illustrates an exemplary flow chart for the SL CSI reporting procedure performed without multiple CSI reporting in parallel in accordance with embodiments of the current invention.

### DETAILED DESCRIPTION

Reference will now be made in detail to some embodiments of the invention, examples of which are illustrated in the accompanying drawings.

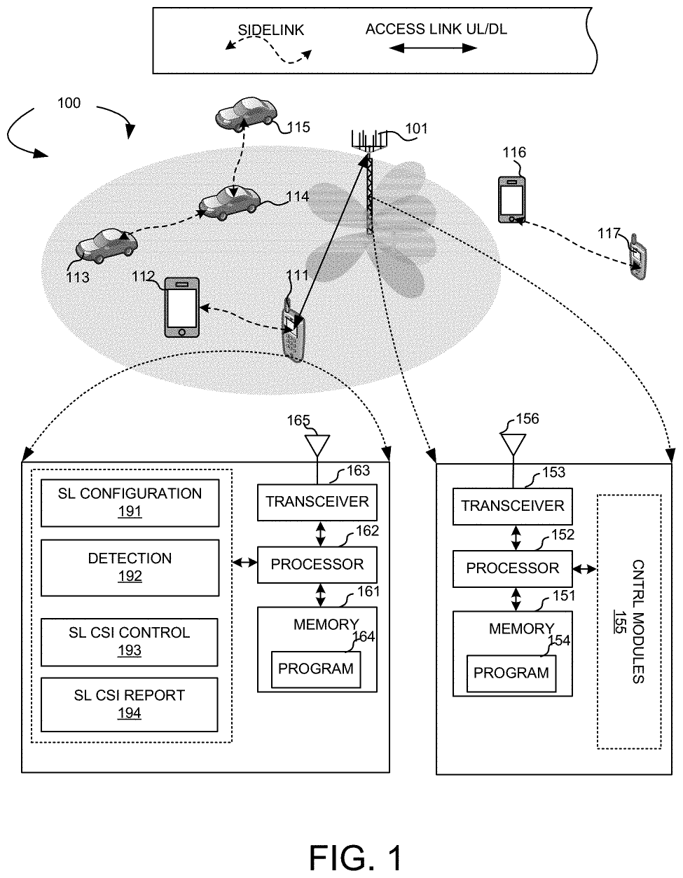

FIG. 1 is a schematic system diagram illustrating an exemplary wireless network for physical layer enhancements for sidelink communication in accordance with embodiments of the current invention in accordance with embodiments of the current invention. Wireless system 100 includes one or more fixed base infrastructure units forming a network distributed over a geographical region. The base unit may also be referred to as an access point, an access terminal, a base station, a Node-B, an eNode-B (eNB), a gNB, or by other terminology used in the art. The network can be a homogeneous network or heterogeneous network, which can be deployed with the same frequency or different frequency. gNB 101 is an exemplary base station in the NR network.

Wireless network 100 also includes multiple communication devices or mobile stations, such as user equipments (UEs) 111, 112, 113, 114, 115, 116, and 117. The exemplary mobile devices in wireless network 100 have sidelink capabilities. The mobile devices can establish one or more connections with one or more base stations, such as gNB 101. UE 111 has an access link, with uplink (UL) and downlink (DL), with gNB 101. UE 112, which is also served by gNB 101, may also establish UL and DL with gNB 101. UE 111 also establishes a sidelink with UE 112. Both UE 111 and UE 112 are in-coverage devices. Mobile devices on vehicles, such as mobile devices 113, 114, and 115, also have sidelink capabilities. Mobile device 113 and mobile device 114 are covered by gNB 101. Mobile device 113, an in-coverage device, establishes sidelink with mobile device 114, which is also an in-coverage device. Mobile device 115 on a vehicle, however, is an out-of-coverage device. In-coverage mobile device 114 establishes a sidelink with the out-of-coverage device 115. In other embodiments, the mobile devices, such as UE 116 and 117, may both be out-of-coverage but can transmit and receive data packets with another one or more other mobile stations with sidelink connections.

FIG. 1 further illustrates simplified block diagrams of a base station and a mobile device/UE for physical layer enhancements. gNB 101 has an antenna 156, which transmits and receives radio signals. An RF transceiver circuit 153, coupled with the antenna, receives RF signals from antenna 156, converts them to baseband signals, and sends them to processor 152. RF transceiver 153 also converts received baseband signals from processor 152, converts them to RF signals, and sends out to antenna 156. Processor 152 processes the received baseband signals and invokes different functional modules to perform features in gNB 101. Memory 151 stores program instructions and data 154 to control the operations of gNB 101. gNB 101 also includes a set of control modules 155 that carry out functional tasks to communicate with mobile stations. These control modules can be implemented by circuits, software, firmware, or a combination of them.

UE 111 has an antenna 165, which transmits and receives radio signals. An RF transceiver circuit 163, coupled with the antenna, receives RF signals from antenna 165, converts them to baseband signals, and sends them to processor 162. In one embodiment, the RF transceiver may comprise two RF modules (not shown). A first RF module is used for HF transmitting and receiving, and the other RF module is used for different frequency bands transmitting and receiving, which is different from the HF transceiver. RF transceiver 163 also converts received baseband signals from processor 162, converts them to RF signals, and sends out to antenna 165. Processor 162 processes the received baseband signals and invokes different functional modules to perform features in the UE 111. Memory 161 stores program instructions and data 164 to control the operations of the UE 111. Antenna 165 sends uplink transmission and receives downlink transmissions to/from antenna 156 of gNB 101.

The UE also includes a set of control modules that carry out functional tasks. These control modules can be implemented by circuits, software, firmware, or a combination of them. A sidelink (SL) configuration module 191 receives an SL configuration for an SL operation using an SL in the wireless network. A detection module 192 triggers a first aperiodic SL channel state information (CSI) reporting upon detecting one or more SL CSI triggering events. An SL CSI control module 193 prohibits a second aperiodic SL CSI reporting until the first aperiodic SL CSI reporting is completed. An SL CSI report module 194 performs SL CSI reporting through the SL based on an SL CSI reporting configuration. The SL configuration is received from the network and/or pre-configuration at the UE.

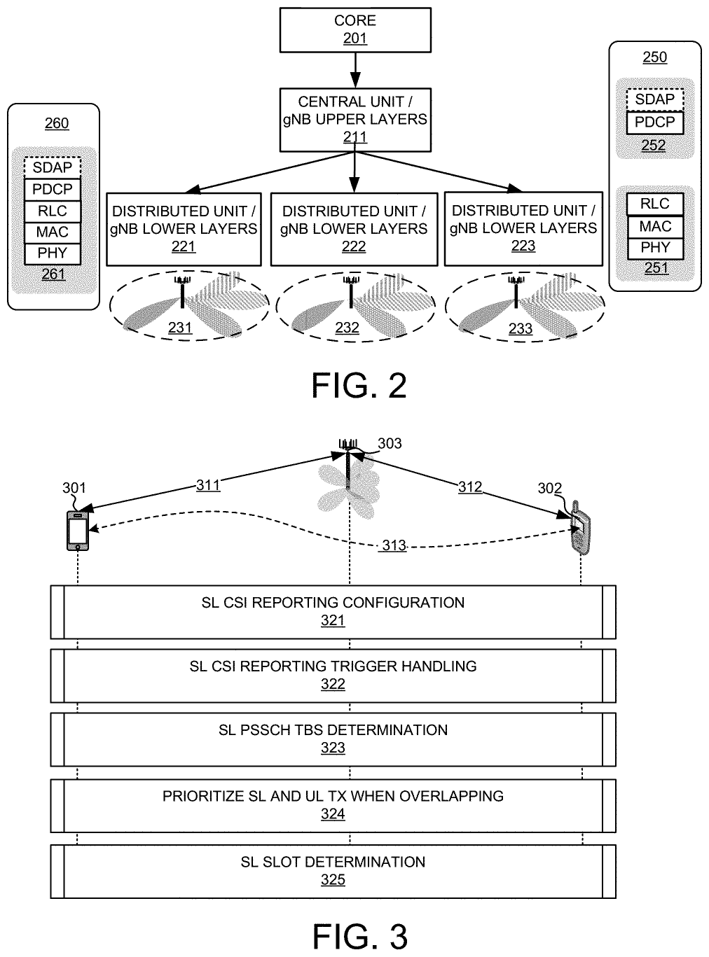

FIG. 2 illustrates an exemplary NR wireless system with centralized upper layers of the NR radio interface stacks in accordance with embodiments of the current invention. Different protocol split options between central unit (CU) and distributed unit (DU) of gNB nodes may be possible. The functional split between the CU and DU of gNB nodes may depend on the transport layer. Low performance transport between the CU and DU of gNB nodes can enable the higher protocol layers of the NR radio stacks to be supported in the CU, since the higher protocol layers have lower performance requirements on the transport layer in terms of bandwidth, delay, synchronization and jitter. In one embodiment, SDAP and PDCP layer are located in the CU, while RLC, MAC and PHY layers are located in the DU. A Core unit 201 is connected with one central unit 211 with gNB upper layer 252. In one embodiment 250, gNB upper layer 252 includes the PDCP layer and optionally the SDAP layer. Central unit 211 is connected with distributed units 221, 222, and 221. Distributed units 221, 222, and 223 each correspond to a cell 231, 232, and 233, respectively. The DUs, such as 221, 222 and 223 include gNB lower layers 251. In one embodiment, gNB lower layers 251 include the PHY, MAC and the RLC layers. In another embodiment 260, each gNB has the protocol stacks 261, including SDAP, PDCP, RLC, MAC and PHY layers.

FIG. 3 illustrates an exemplary top-level functional diagram for the physical layer enhancements for the sidelink communication in accordance with embodiments of the current invention. UE 301 and UE 302 are connected with gNB 303 in the NR network through Uu links 311 and 312, respectively. In an NR wireless network, a sidelink 313 between UE 301 and UE 302 is enabled. NR vehicle to everything (V2X) supports the transmission of CSI-RS. CSI-RS is confined with physical sidelink shared channel (PSSCH) transmission and it can only be transmitted if SL CQI/RI report is enabled by higher layer signaling. The SL CQI/RI report from RX UE is enabled by sidelink control information (SCI) at physical layer to help the TX UE to do link adaption. In one embodiment 321, SL CSI reporting configuration is performed based on the SL configuration. The UE configures the CSI reporting based on an association between the CSI trigger and the reported CSI, either explicitly or implicitly. In another embodiment 322, the SL CSI reporting procedure is performed without multiple CSI reporting in parallel. In one embodiment 323, the PSFCH overhead indicator is used for SL PSSCH TBS determination. In one embodiment 324, the prioritization is performed between sidelink synchronization signal block (S-SSB) and UL transmission when the S-SSB transmission overlaps with the UL transmission. In another embodiment 325, SL slot is configured.

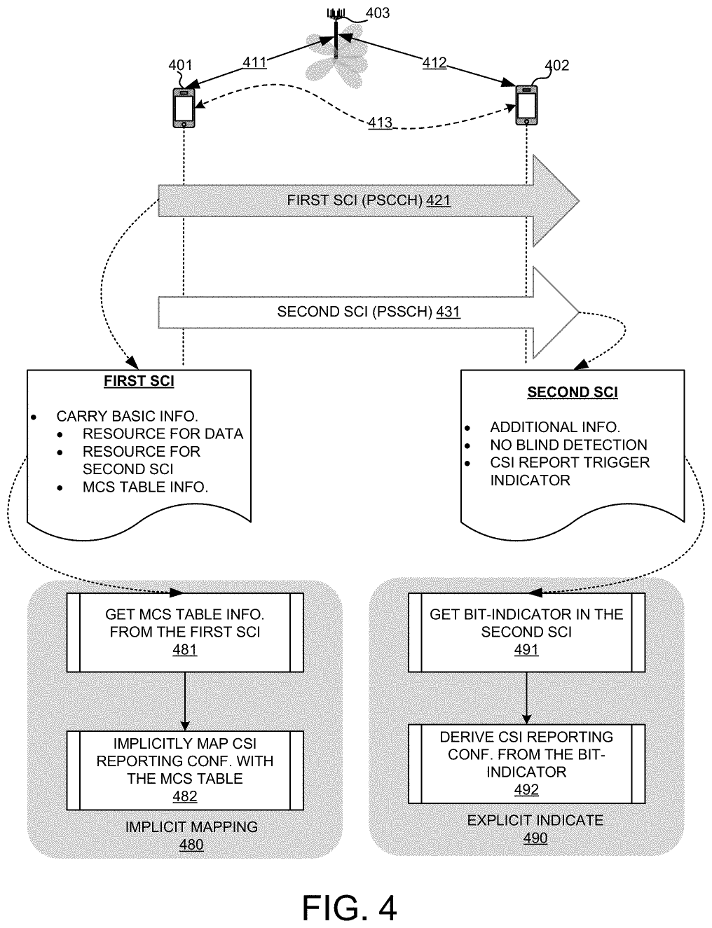

FIG. 4 illustrates exemplary diagrams for the SL CSI reporting configuration in accordance with embodiments of the current invention. UE 401 and UE 402 are connected with gNB 403 in the NR network through Uu links 411 and 412, respectively. In an NR wireless network, a sidelink 413 between UE 401 and UE 402 is enabled. In the NR network, the SCI is defined as the counterpart of data control information (DCI) for physical downlink control channel (PDCCH). The SCI is transmitted on the PSCCH for the sidelink communication and supports a two-stage control channel design. At step 421, a first SCI (for instance, a first stage SCI) is transmitted via the sidelink 413 on the PSCCH. Receiving of the first stage SCI requires blind detection. The first SCI carries the basic information such as resource allocation for the data channel and resource allocation for the second SCI. The first SCI also carries information for the modulation and coding scheme (MCS) table. At step 431, a second SCI is transmitted. The second SCI does not need blind detection. The second SCI carries additional information that is not used for scheduling. In one embodiment, the second SCI carries the SL CSI report trigger indicator for the aperiodic SL CSI report.

For SL CSI reporting, there is an association between the CSI trigger and the reported CSI. In one embodiment 480, the association is implicitly mapped. In another embodiment 490, the association is explicitly indicated. The implicitly mapping 480 maps the CSI reporting configuration by implicitly linking to the CSI table, which is associated with the MCS table indicated in first SCI. At step 481, the UE get the MCS table information from the first SCI. At step 482, the UE implicitly maps the CSI reporting configuration with the MCS table. The CSI table for CSI reporting is implicitly associated with the used MCS table indicated in the triggered SCI. For example, if the first SCI indicates using 64QAM MCS table for the data transmission and CSI reporting is also triggered in the corresponding second SCI, then the 64QAM CSI table corresponding to 64QAM MCS table will be assumed for SL CSI reporting. In another embodiment 490, the SL CSI reporting configuration is explicitly indicated. When multiple CSI tables configured or preconfigured, an indicator is needed in second SCI (for instance, a second stage SCI) to indicate which CSI table is assumed for the SL CSI reporting. At step 491, the UE get a bit-indicator in the second SCI. At step 492, the SL CSI reporting configuration is derived from the bit-indicator. The bit-indicator is a non-scrambled indicator with one or more bits in the second SCI. The one or more bit-indicator explicitly indicates the configuration for the SL CSI reporting. In one embodiment, the second SCI that carries this bit-indicator also carries the SL CSI reporting trigger indicator. To secure the association between the assumed SL CSI table and SL CSI reports, it assumes that there is no multiple CSI reporting in parallel.

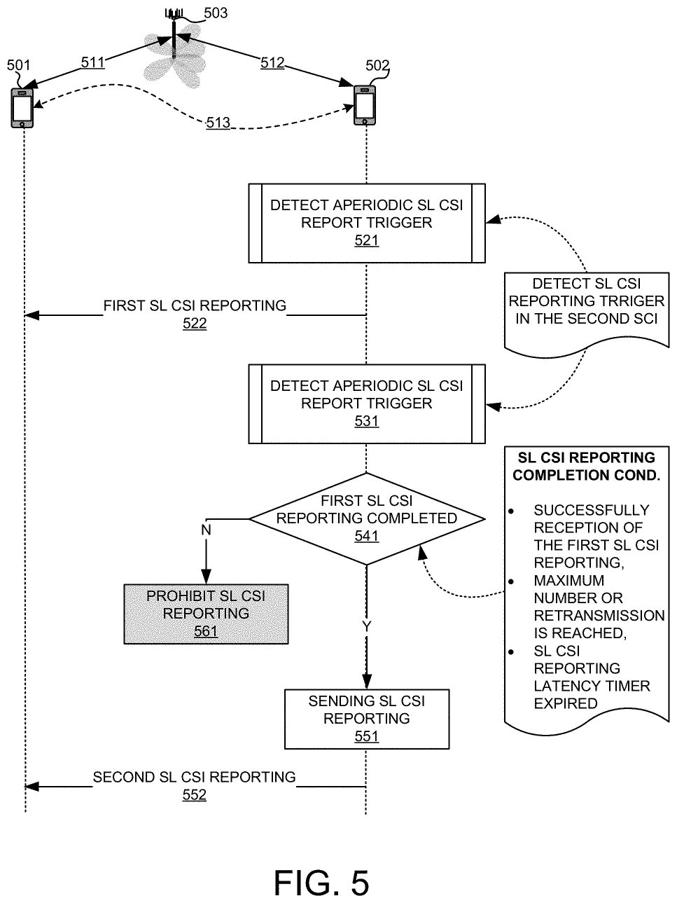

FIG. 5 illustrates exemplary diagrams for the SL CSI reporting procedure performed without multiple CSI reporting in parallel in accordance with embodiments of the current invention. UE 501 and UE 502 are connected with gNB 503 in the NR network through Uu links 511 and 512, respectively. In an NR wireless network, a sidelink 513 between UE 501 and UE 502 is enabled. In the NR network, the aperiodic SL CSI reporting is performed at the MAC layer with HARQ retransmission. The retransmission of the SL CSI reports may cause the out-of-order and/or out-of-date CSI reports at the receiving side. In one embodiment, to avoid the problem, a prohibition procedure is implemented for the aperiodic SL CSI reporting process. At step 521, UE 502 detects one trigger for the aperiodic SL CSI reporting. In one embodiment, the SL CSI reporting is triggered by the second SCI. At step 522, UE 502 sends the first aperiodic SL CSI report. At step 531, UE 502 detects a second aperiodic SL CSI reporting trigger. At step 541, UE 502 determines if the first aperiodic SL CSI reporting is completed. In one embodiment, the first SL CSI reporting is completed upon detecting one or more conditions. The conditions comprise one or more of: a successfully reception of the first SL CSI reporting, a maximum number of (re-)transmission is reached, and a SL CSI reporting latency timer expired. For example, the next or new trigger for SL CSI reporting is only allowed after receiving the corresponding CSI reports and/or fail to receive CSI reports due to reaching maximum (re-) transmission times and/or exceeding the latency bound for the CSI reporting. In another embodiment, a latency timer at the Tx UE, UE 502, triggering SL CSI reporting is configured. The latency timer starts when the CSI reporting is triggered and stops when the corresponding CSI report is received correctly. If the latency timer is expired or stopped, a new CSI reporting is triggered. Otherwise, the new CSI reporting is not allowed. If step 541 determines NO, UE 502 moves to step 561 and prohibits the transmission of the second SL CSI report. If step 541 determines YES, UE 502 moves to step 551 to prepare to send the second aperiodic SL CSI report. At step 552, UE 502 sends the second aperiodic SL CSI report. In other embodiments, when the SL carrier aggregation (CA) is configured, the multiple CSI-reporting procedures are supported for a UE. However, at most one ongoing CSI reporting process per CA or per SL bandwidth part (BWP) or per resource pool for a UE is allowed. There are no multiple ongoing CSI reporting processes in parallel.

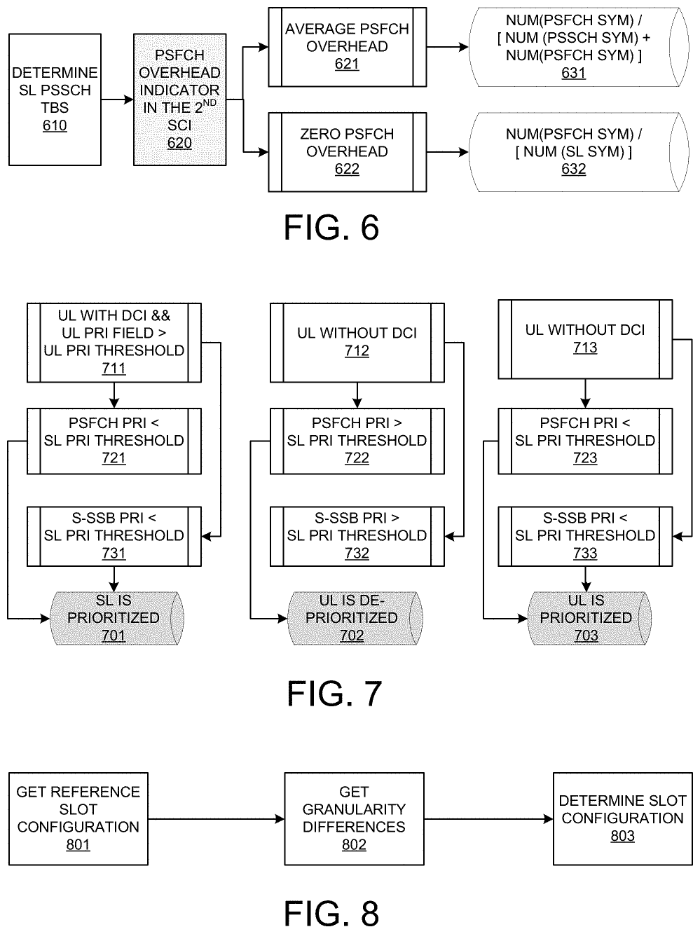

FIG. 6 illustrates exemplary diagrams for using the PSFCH overhead indicator for SL PSSCH TBS determination in accordance with embodiments of the current invention. For SL PSSCH TBS determination, a PSFCH overhead indicator can be carried in 2nd stage SCI. At step 610, the UE performs the determination of the SL PSSCH TBS. At step 620, the UE obtains the PSFCH overhead indicator in the second stage SCI. The PSFCH overhead indicator indicates whether the average overhead 621 or zero PSFCH overhead 622 is assumed for a TB across the initial transmission and re-transmission(s). At step 631, the average PSFCH overhead is assumed, the value is derived by the ratio of the total number of PSFCH symbols over the total number of symbols of PSSCH and PSFCH across all slots. For example, given PSFCH resources are configured every two slots with three symbols of PSFCH resources including the associated GP symbol and total N PSSCH symbols, with or without automatic gain control (AGC) symbols, over two slots (e.g., twelve PSSCH symbols in a first slot w/o PSFCH and nine PSSCH symbols in a second slot with PSFCH if AGC symbol is included). The average PSFCH overhead will be 3/(12+9+3)=3/24=12.5%. The number of PSSCH symbols in a slot is up to resource pool configuration and the presence of the PSFCH resources. At step 632, when zero PSFCH overhead is assumed, the overhead is defined as the ratio of the total number of PSFCH symbols over the total number of SL symbols in a slot (w/wo GP/AGC symbols) over the period for PSFCH slot configuration.

FIG. 7 illustrates exemplary diagrams for the prioritization performed between SL and the UL transmission when overlapping in accordance with embodiments of the current invention. When SL and UL overlaps, prioritization is needed. In one novel aspect, the prioritization is based on DCI configuration for the UL and preconfigured priority thresholds.

In one embodiment, when PSFCH transmission overlaps with the UL transmission that is not the PUCCH carrying SL HARQ reporting, the prioritization is based on UL DCI information, PSFCH priority and priority threshold. In scenario 701, the SL is prioritized when (711) UL transmission is associated with a DCI with the “priority field” and the priority level indicated by the “priority field” (e.g., 0 means “high”, 1 means “low”) in DCI for the associated UL transmission is larger than the UL priority field threshold, and (721) the priority level of PSFCH (e.g., indicated in the associated SCI) is lower than the SL priority threshold. Otherwise, the UL transmission is prioritized (703). In scenario 702, the UL is deprioritized if (712) UL transmission is not associated with a DCI with the “priority field”, and (722) the priority level of PSFCH is higher than SL-threshold. In scenario 703, the UL is prioritized when (713) UL transmission is not associated with a DCI with the “priority field”, and (723) the priority level of PSFCH is lower than SL-threshold.

In another embodiment, when S-SSB transmission overlaps with the UL transmission that is not the PUCCH carrying SL HARQ reporting, the prioritization is based on UL DCI information, S-SSB priority and priority threshold. In scenario 701, the SL is prioritized when (711) UL transmission is associated with a DCI with the “priority field” and the priority level indicated by the “priority field” (e.g., 0 means “high”, 1 means “low”) in DCI for the associated UL transmission is larger than the UL priority field threshold, and (731) the priority level of S-SSB is lower than the SL priority threshold. Otherwise, the UL transmission is prioritized (703). In scenario 702, the UL is deprioritized if (712) UL transmission is not associated with a DCI with the “priority field”, and (732) the priority level of S-SSB is higher than SL-threshold. In scenario 703, the UL is prioritized when (713) UL transmission is not associated with a DCI with the “priority field”, and (733) the priority level of S-SSB is lower than SL-threshold.

FIG. 8 illustrates exemplary diagrams for SL slot configuration that derives UE UL or SL dual-period pattern (P1, P2) with the same period on P1 and P2 from a reference dual-period pattern in accordance with embodiments of the current invention. The UL slots in the dual-period patterns with the same period on P1 and P2 can be derived from the reference dual-period pattern indicated in the signalling. At step 801, the UE obtains a reference slot configuration. For example, for the dual-period pattern {P1, P2}={5 ms, 5 ms}, the UL (or SL) slots for the pattern {5 ms, 5 ms} can be indicated by some bits indicating the consecutive UL (or SL) slots. For the other patterns with the same period in P1 and P2, e.g., {2 ms, 2 ms}, {2.5 ms, 2.5 ms} and {10 ms, 10 ms}, they can refer to indication of UL (or SL) slots in {5 ms, 5 ms} reference pattern to derive the corresponding UL (or SL) slots in P1 and P2 respectively. At step 802 the UE gets the granularity differences between the slots to be configured and the reference slot configuration. At step 802, the slot configuration is determined. That is, for a target dual-period pattern {Pt, Pt}, the UL slots in P1 and P2 can be derived by using the indicated UL slots in P1 and P2 in a reference pattern {Pr,Pr} as such:

UL_slots_{Pt,Pt}_P1=floor(UL_slots_{Pr,Pr}_P1/Pr*Pt),

UL_slots_{Pt,Pt}_P2=floor(UL_slots_{Pr,Pr}_P2/Pr*Pt),

wherein Pt is, e.g., 2 ms, 2.5 ms and 10 ms for the corresponding target dual-period patterns {2 ms, 2 ms}, {2.5 ms, 2.5 ms} and {10 ms, 10 ms}, and Pr is the period of the reference pattern, e.g., 5 ms if {5 ms, 5 ms} dual-period pattern is defined as the reference pattern. The UL slots associated with a pattern can be derived from the TDD UL/DL configuration indicated in SIB. In case of the different numerology used for SL and Uu interface, the numerology difference between SL and Uu should be taken into account to derive the number of UL (or potential SL) slots indicated in SL SSB. For example, if SCS of Uu and SL are 15 khz and 30 khz, respectively, the UL_slots_SL_u1=floor(UL_slots_uu_u2*2\hat{ }(u1−u2)), wherein u1 and u2 belong to u={0,1,2,3} corresponding to 15 khz, 30 khz, 60 khz and 120 khz numerology.

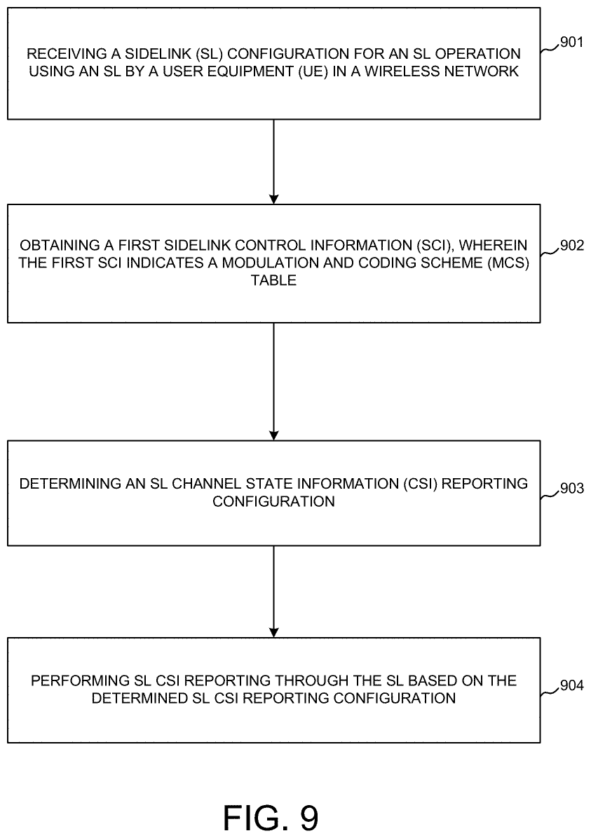

FIG. 9 illustrates an exemplary flow chart for the SL CSI reporting configuration in accordance with embodiments of the current invention. At step 901, the UE receives a sidelink (SL) configuration for an SL operation using an SL in a wireless network. At step 902, the UE obtains a first sidelink control information (SCI), wherein the first SCI indicates a modulation and coding scheme (MCS) table. At step 903, the UE determines an SL channel state information (CSI) reporting configuration. At step 904, the UE performs SL CSI reporting through the SL based on the determined SL CSI reporting configuration.

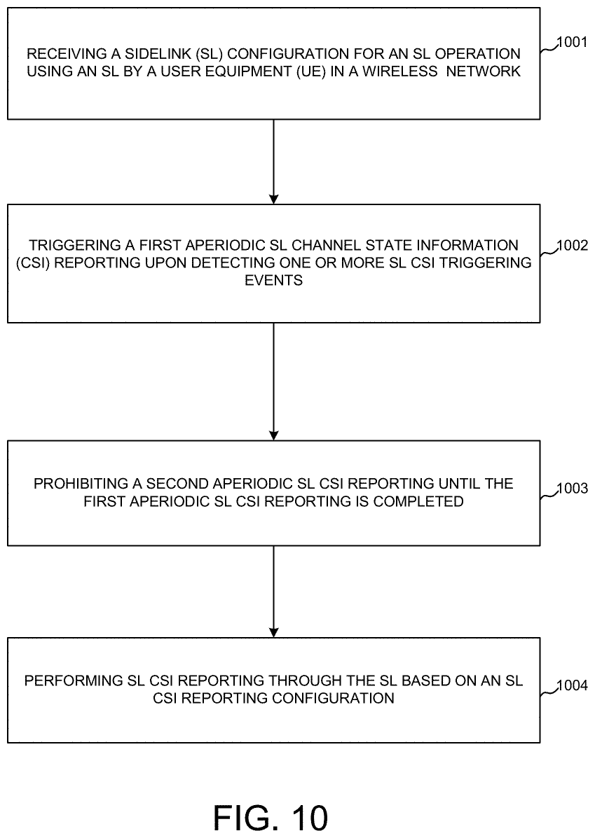

FIG. 10 illustrates an exemplary flow chart for the SL CSI reporting procedure performed without multiple CSI reporting in parallel in accordance with embodiments of the current invention. At step 1001, the UE receives a sidelink (SL) configuration for an SL operation using an SL in a wireless network. At step 1002, the UE a first aperiodic SL channel state information (CSI) reporting upon detecting one or more SL CSI triggering events. At step 1003, the UE prohibits a second aperiodic SL CSI reporting until the first aperiodic SL CSI reporting is completed. At step 1004, the UE performs SL CSI reporting through the SL based on an SL CSI reporting configuration.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
receiving a sidelink (SL) configuration for an SL operation using an SL by a user equipment (UE) in a wireless network;
obtaining a first sidelink control information (SCI), wherein the first SCI indicates a modulation and coding scheme (MCS) table;
determining an SL channel state information (CSI) reporting configuration; and
performing SL CSI reporting through the SL based on the determined SL CSI reporting configuration.

2. The method of claim 1, wherein SL CSI reporting configuration is explicitly indicated by an SL CSI reporting indicator in a second SCI.

3. The method of claim 2, wherein the SL CSI reporting indicator is a non-scrambled indicator with one or more bits in the second SCI.

4. The method of claim 2, wherein the second SCI triggers a CSI reporting by the UE.

5. The method of claim 1, wherein the SL CSI reporting configuration is implicitly mapped based on the MCS table in the first SCI.

6. A method, comprising:
receiving a sidelink (SL) configuration for an SL operation using an SL by a user equipment (UE) in a wireless network;
triggering a first aperiodic SL channel state information (CSI) reporting upon detecting one or more SL CSI triggering events;
prohibiting a second aperiodic SL CSI reporting until the first aperiodic SL CSI reporting is completed; and
performing SL CSI reporting through the SL based on an SL CSI reporting configuration.

7. The method of claim 6, wherein the first aperiodic SL CSI reporting is completed upon detecting one or more conditions comprising a successfully reception of the first aperiodic SL CSI reporting, a maximum number of transmission or retransmission is reached, and a SL CSI reporting latency timer expired.

8. The method of claim 6, wherein the SL CSI triggering event is receiving a second sidelink control information (SCI).

9. The method of claim 6, wherein the second aperiodic SL CSI reporting is triggered by the one or more SL CSI triggering events.

10. The method of claim 6, wherein the SL CSI reporting configuration is implicitly mapped based on a MCS table in a first SCI.

11. The method of claim 6, wherein the SL CSI reporting configuration is explicitly indicated a second SCI.

12. A user equipment (UE), comprising:
a transceiver that transmits and receives radio frequency (RF) signal in a wireless network;
a sidelink (SL) configuration module that receives a sidelink (SL) configuration for an SL operation using an SL in the wireless network;
a detection module that triggers a first aperiodic SL channel state information (CSI) reporting upon detecting one or more SL CSI triggering events;
an SL CSI control module that prohibits a second aperiodic SL CSI reporting until the first aperiodic SL CSI reporting is completed; and
an SL CSI report module that performs SL CSI reporting through the SL based on an SL CSI reporting configuration.

13. The UE of claim 12, wherein the first aperiodic SL CSI reporting is completed upon detecting one or more conditions comprising a successfully reception of the first SL CSI reporting, a maximum number or retransmission is reached, and a SL CSI reporting latency timer expired.

14. The UE of claim 12, wherein the SL CSI triggering event is receiving a second sidelink control information (SCI).

15. The UE of claim 12, wherein the second aperiodic SL CSI reporting is triggered by the one or more SL CSI triggering events.

16. The UE of claim 12, further comprising a CSI reporting configuration module that obtains the SL CSI reporting configuration based on a first SCI.

17. The of claim 16, wherein the SL CSI reporting configuration is implicitly mapped based on a modulation and coding scheme (MCS) table in the first SCI.

18. The UE of claim 12, wherein the SL CSI reporting configuration is explicitly indicated by an SL CSI reporting indicator in a second SCI.

19. The UE of claim 18, wherein the SL CSI reporting indicator is a non-scrambled indicator with one or more bits in the second SCI.
